(19) United States
(12) Patent Application Publication
(10) Pub. No.: US 2023/0162193 A1
(43) Pub. Date: May 25, 2023

(54) SALES SUPPORT APPARATUS, SALES SUPPORT METHOD, AND NONTRANSITORY COMPUTER-READABLE STORAGE MEDIUM

(71) Applicant: NEC Corporation, Minato-ku, Tokyo (JP)

(72) Inventor: Maya TAKABATAKE, Tokyo (JP)

(73) Assignee: NEC Corporation, Minato-ku, Tokyo (JP)

(21) Appl. No.: 17/922,832

(22) PCT Filed: Apr. 26, 2021
(86) PCT No.: PCT/JP2021/016587

§ 371 Date: Nov. 2, 2022

(30) Foreign Application Priority Data
May 13, 2020 (JP) 2020-084544

(51) Int. Cl. G06Q 20/40

(52) U.S. Cl. CPC G06Q 20/40145

(57) ABSTRACT

A sales support apparatus includes an age estimation unit that acquires a face image capturing a face of a person being in front of equipment in which a specific product is displayed, and executes age estimation of the person by use of the face image, when a result of the age estimation by the age estimation unit does not satisfy a criterion, an age confirmation unit that requests the person for age certification information, and determines whether the acquired age certification information satisfies a criterion, and when a result of the determination by the age confirmation unit satisfies the criterion, a processing unit that allows the specific product to be taken out of the equipment, and registers the face image as a master face image, together with the age certification information, in the storage apparatus for subsequent occasions of authentication.

### TECHNICAL FIELD

The present invention relates to a sales system, a sales support apparatus, a sales support method, and a program.

### BACKGROUND ART

It is known that, in an unmanned or labor-saving store, age estimation is performed from a face image of a customer, personal identification is performed, and age confirmation is performed, in order to sell a product such as alcohol or tobacco with age restriction.

Patent Document 1 describes a sales support system that estimates an age of a customer by use of biological information of the customer when a bar code of an age-restricted product is read at a point of sales (POS) cash register, scans an ID card owned by the customer and acquires an actual age of the customer when the estimated age is less than a predetermined age, and determines an age.

Patent Document 2 describes that, when a store visitor is sensed at a product exchange booth, an image captured by a camera is transmitted to a centralized sale center, age confirmation is performed, and then the store visitor is brought into a state of being capable of purchasing an age-restricted product.

### RELATED DOCUMENTS

### Patent Documents

Patent Document 1: International Patent Publication No. WO2017/046995

Patent Document 2: Japanese Patent Application Publication No. 2008-171083

### SUMMARY OF INVENTION

### Technical Problem

On the other hand, in an unmanned or labor-saving store, equipment that houses an age-restricted product is designed in such a way that a customer cannot take freely. Thus, convenience of a customer is impaired.

The present invention has been made in view of the circumstances described above, and an object thereof is to improve convenience of a customer when a specific product is sold, in an unmanned or labor-saving store.

### Solution to Problem

Each aspect of the present invention adopts each of the following configurations, in order to solve the problem described above.

A first aspect relates to a sales support apparatus.

A first sales support apparatus according to the first aspect includes:

an age estimation unit; an age confirmation unit; a processing unit; and a storage unit, wherein

the age estimation unit acquires a face image capturing a face of a person being in front of equipment in which a specific product is displayed, and executes age estimation of the person by use of the face image,

when a result of the age estimation by the age estimation unit does not satisfy a criterion, the age confirmation unit requests the person for age certification information, and determines whether the acquired age certification information satisfies a criterion, and,

when a result of the determination by the age confirmation unit satisfies a criterion, the processing unit allows the specific product to be taken out of the equipment, and registers the face image as a master face image, together with the age certification information, in the storage unit for subsequent occasions of authentication.

A second sales support apparatus according to the first aspect

includes:

an age estimation unit; a processing unit; a collation unit; and a storage unit, wherein

when a person enters a store, the age estimation unit acquires a face image capturing a face of the person, and executes age estimation by use of the face image,

the processing unit registers the face image in the storage unit as a master face image, in a state where whether a result of the age estimation satisfies a criterion is determinable,

when a person stands in front of equipment in which a specific product is displayed, the collation unit acquires a collation target face image capturing a face of the person being in front of the equipment, and collates the acquired collation target face image with the master face image registered in the storage unit,

when the master face image corresponding to the collation target face image is present in the storage unit, and a result of the age estimation satisfies a criterion, the processing unit allows the specific product to be taken out of the equipment,

when the master face image corresponding to the collation target face image is not present in the storage unit according to the collation unit, the age estimation unit executes age estimation by use of the collation target face image, and,

when the result of the age estimation satisfies the criterion, the processing unit allows the specific product to be taken out of the equipment, and registers the collation target face image as the master face image, together with the result of the age estimation, in the storage unit.

A second aspect relates to a sales support method executed by at least one computer.

A first sales support method according to the second aspect includes,

by a sales support apparatus:

acquiring a face image capturing a face of a person being in front of equipment in which a specific product is displayed, and executing age estimation of the person by use of the face image;

when a result of the age estimation does not satisfy a criterion, requesting the person for age certification information, and determining whether the acquired age certification information satisfies a criterion; and,

when a result of the determination satisfies a criterion, allowing the specific product to be taken out of the equipment, and registering the face image as a master face image, together with the age certification information, in a storage unit for subsequent occasions of authentication.

A second sales support method according to the second aspect includes,

by a sales support apparatus:

when a person enters a store, acquiring a face image capturing a face of the person, and executing age estimation by use of the face image;

registering the face image in a storage unit as a master face image, in a state where whether a result of the age estimation satisfies a criterion is determinable;

when a person stands in front of equipment in which a specific product is displayed, acquiring a collation target face image capturing a face of the person being in front of the equipment, and collating the acquired collation target face image with the master face image registered in the storage unit;

when the master face image corresponding to the collation target face image is present in the storage unit, and a result of the age estimation satisfies a criterion, allowing the specific product to be taken out of the equipment;

when the master face image corresponding to the collation target face image is not present in the storage unit, executing age estimation by use of the collation target face image; and,

when the result of the age estimation satisfies the criterion, allowing the specific product to be taken out of the equipment, and registering the collation target face image as the master face image, together with the result of the age estimation, in the storage unit.

A third aspect relates to a sales system.

A first sales system according to the third aspect includes:

equipment that displays a specific product; and

a sales support apparatus, wherein

the sales support apparatus includes

an age estimation unit, an age confirmation unit, a processing unit, and a storage unit,

the age estimation unit acquires a face image capturing a face of a person being in front of equipment in which a specific product is displayed, and executes age estimation of the person by use of the face image,

when a result of the age estimation by the age estimation unit does not satisfy a criterion, the age confirmation unit requests the person for age certification information, and determines whether the acquired age certification information satisfies a criterion, and,

when a result of the determination by the age confirmation unit satisfies a criterion, the processing unit allows the specific product to be taken out of the equipment, and registers the face image as a master face image, together with the age certification information, in the storage unit for subsequent occasions of authentication.

A second sales system according to the third aspect includes:

equipment that displays a specific product; and

a sales support apparatus, wherein

the sales support apparatus includes

an age estimation unit, a processing unit, a collation unit, and a storage unit,

when a person enters a store, the age estimation unit acquires a face image capturing a face of the person, and executes age estimation by use of the face image,

the processing unit registers the face image in the storage unit as a master face image, in a state where whether a result of the age estimation satisfies a criterion is determinable,

when a person stands in front of equipment in which a specific product is displayed, the collation unit acquires a collation target face image capturing a face of the person being in front of the equipment, and collates the acquired collation target face image with the master face image registered in the storage unit,

when the master face image corresponding to the collation target face image is present in the storage unit, and a result of the age estimation satisfies a criterion, the processing unit allows the specific product to be taken out of the equipment,

when the master face image corresponding to the collation target face image is not present in the storage unit according to the collation unit, the age estimation unit executes age estimation by use of the collation target face image, and,

when the result of the age estimation satisfies the criterion, the processing unit allows the specific product to be taken out of the equipment, and registers the collation target face image as the master face image, together with the result of the age estimation, in the storage unit.

Note that, another aspect of the present invention may be a program that causes at least one computer to execute the method according to the second aspect described above, or may be a computer-readable storage medium recording such a program. The storage medium includes a non-transitory tangible medium.

The computer program includes a computer program code that causes, when executed by a computer, the computer to implement the sales support method on the sales support apparatus.

Note that, each of conversions of any combination of above components and an expression of the present invention between a method, an apparatus, a system, a storage medium, a computer program, and the like is also effective as a form of the present invention.

Moreover, each of a variety of components of the present invention does not necessarily need to be individually independent existence, and may be in such a form that a plurality of components are formed as one member, one component is formed of a plurality of members, a certain component is a part of another component, or a part of a certain component overlaps a part of another component.

Moreover, although a plurality of procedures are described in order in each of the method and the computer program of the present invention, an order of the descriptions does not limit an order of executing the plurality of procedures. Thus, when each of the method and the computer program of the present invention is implemented, an order of the plurality of procedures can be changed to an extent that causes no problem in terms of content.

Furthermore, a plurality of procedures of each of the method and the computer program of the present invention are not limited to being executed at individually differing timings. Thus, a plurality of procedures may be in such a form that, during execution of a certain procedure, another procedure occurs, an execution timing of a certain procedure and an execution timing of another procedure partly or entirely overlap each other, or the like.

### Advantageous Effects of Invention

Each of the aspects described above can improve convenience of a customer when a specific product is sold, in an unmanned or labor-saving store.

### BRIEF DESCRIPTION OF THE DRAWINGS

FIG. 1 is a diagram schematically illustrating a system configuration of a sales system according to the present example embodiment of the present invention.

FIG. 2 is a block diagram illustrating a hardware configuration of a computer that achieves a sales support apparatus.

FIG. 3 is a functional block diagram logically illustrating a configuration of a sales support apparatus according to an example embodiment.

FIG. 4 is a diagram illustrating one example of a data structure of authentication information.

FIG. 5 is a flowchart illustrating an operation example of the sales support apparatus according to the example embodiment.

FIG. 6 is a flowchart illustrating one example of subsequent processing in FIG. 5.

FIG. 7 is a functional block diagram illustrating a logical configuration example of the sales support apparatus according to the example embodiment.

FIG. 8 is a diagram illustrating one example of a data structure of age estimation result information.

FIG. 9 is a flowchart illustrating one example of an operation of the sales support apparatus according to the example embodiment.

FIG. 10 is a flowchart illustrating one example of an operation of the sales support apparatus according to the example embodiment.

FIG. 11 is a functional block diagram illustrating a logical configuration example of the sales support apparatus according to the example embodiment.

FIG. 12 is a flowchart illustrating one example of an operation of the sales support apparatus according to the example embodiment.

FIG. 13 is a diagram schematically illustrating a system configuration of the sales system according to the example embodiment.

FIG. 14 is a flowchart illustrating one example of an operation of the sales support apparatus according to the example embodiment.

FIG. 15 is a flowchart illustrating an operation example of the sales support apparatus according to the example embodiment.

FIG. 16 is a flowchart illustrating an operation example of the sales support apparatus according to the example embodiment.

FIG. 17 is a flowchart illustrating an operation example of an acquisition procedure of age certification information.

FIG. 18 is a diagram for describing an acquisition method of age certification information by an identification card.

FIG. 19 is a diagram for describing an opening and closing method of a door of equipment by bar code utilization.

### EXAMPLE EMBODIMENT

Hereinafter, an example embodiment of the present invention is described by use of the drawings. Note that, in all of the drawings, a similar component is assigned with a similar reference sign, and description thereof is not included, as appropriate. In each of the following diagrams, a configuration of a part that does not concern essence of the present invention is not included, and is not illustrated.

In the example embodiment, “acquisition” includes at least one of fetching, by a local apparatus, data or information stored in another apparatus or a storage medium (active acquisition), and inputting, into a local apparatus, data or information output from another apparatus (passive acquisition). Examples of active acquisition include requesting or inquiring of the another apparatus and receiving a reply thereof, accessing the another apparatus or the storage medium and reading, and the like. Moreover, an example of passive acquisition includes receiving information given by distribution (or transmission, push notification, or the like), and the like. Further, “acquisition” may include selecting and acquiring from received data or information, or selecting and receiving distributed data or information.

### First Example Embodiment

### <System Outline>

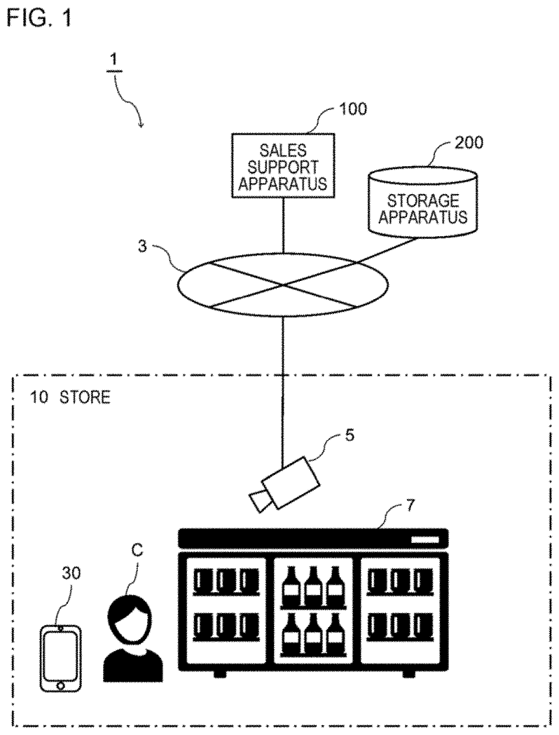

FIG. 1 is a diagram schematically illustrating a system configuration of a sales system 1 according to an example embodiment of the present invention.

The sales system 1 includes a sales support apparatus 100, a storage apparatus 200, and a camera 5. A store 10 assumes a scene in which an unmanned or labor-saving operation style is performed. The unmanned or labor-saving operation style also includes a case where a clerk is in a so-called one-person-operation state (a state where one person runs a store). Equipment 7 in which a product 20 is displayed is placed in the store 10. Further, a specific product 22 such as alcohol or tobacco with age restriction is also displayed in the equipment 7.

The storage apparatus 200 is connected to the sales support apparatus 100 via a communication network 3. However, the storage apparatus 200 may be an apparatus included inside the sales support apparatus 100, may be an apparatus being separate from the sales support apparatus 100, or may be a combination of the apparatuses.

The equipment 7 in which the specific product 22 is displayed has a structure being equipped with, for example, a door, in such a way that a customer C cannot take the specific product 22 freely. For example, the door may be controlled by the sales support apparatus 100 in such a way that the door does not open, the door may be locked by a key that restricts opening and closing of the door, or a mechanism for holding the specific product 22 may grasp the specific product 22, in such a way that the specific product 22 cannot be taken out.

The sales system 1 further communicates with a portable terminal 30. The portable terminal 30 is, for example, a smartphone, a tablet terminal, or the like. The portable terminal 30 may be a belonging of the customer C, or may be prepared in the store 10 and lent to the customer C. A predetermined application is installed in the portable terminal 30. The predetermined application has a function of capturing a face and an identification card of the customer C with a camera of the portable terminal 30, and transmitting an image to the sales support apparatus 100. Note that, the sales system 1 may include the portable terminal 30.

The camera 5 captures the customer C, and generates an image. The camera 5 includes a lens, and an image capturing element such as a charge coupled device (CCD) image sensor.

The camera 5 may include a mechanism of tracking in response to motion of a person entering a field angle, and performing orientational control, zoom control, focusing, and the like of a camera body or a lens.

An image generated by the camera 5 is preferably captured in real time and transmitted to the sales support apparatus 100 via the communication network 3. However, an image transmitted to the sales support apparatus 100 may not be transmitted directly from the camera 5, and may be an image delayed a predetermined time. An image captured by the camera 5 may be temporarily stored in another storage apparatus, and the sales support apparatus 100 may read the image from the storage apparatus sequentially or at each predetermined interval. Further, an image transmitted to the sales support apparatus 100 is preferably a moving image, but may be a frame image at each predetermined interval, or may be a still image.

### <Hardware Configuration Example>

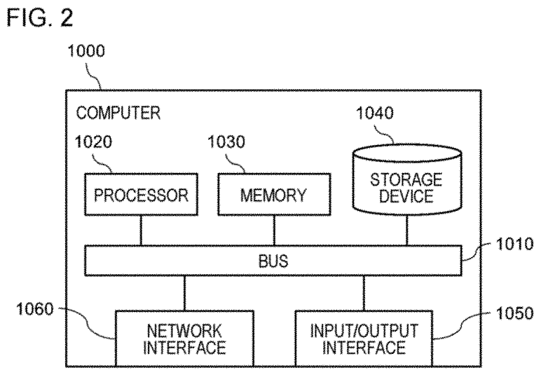

FIG. 2 is a block diagram illustrating a hardware configuration of a computer 1000 that achieves the sales support apparatus 100. The portable terminal 30 in FIG. 1 is also achieved by the computer 1000.

The computer 1000 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (e.g., an age estimation unit 102, an age confirmation unit 104, a processing unit 106, and a collation unit 108, and the like that are described later) of the sales support apparatus 100. The processor 1020 reads each of the program modules onto the memory 1030, executes the read program module, and thereby achieves each function being relevant to the program module. Moreover, the storage device 1040 may also store each piece of data of the storage apparatus 200.

The program module may be recorded in a storage medium. A storage medium recording the program module may include a medium usable by the non-transitory tangible computer 1000, and a program code readable by the computer 1000 (the processor 1020) may be embedded in the medium.

The input/output interface 1050 is an interface for connecting the computer 1000 to various kinds of input/output device. The input/output interface 1050 also functions as a communication interface that performs near field wireless communication such as a Bluetooth (registered trademark) or a near field communication (NFC).

The network interface 1060 is an interface for connecting the computer 1000 to a communication network. The communication network is, for example, a local area network (LAN) or a wide area network (WAN). A method of connecting the network interface 1060 to a communication network may be wireless connection, or may be wired connection.

Then, the computer 1000 is connected to a necessary device (e.g., the portable terminal 30, the camera 5, or the like) via the input/output interface 1050 or the network interface 1060.

The sales support apparatus 100 may be constituted of a plurality of computers 80, or may be achieved by a virtual server.

### <Functional Configuration Example>

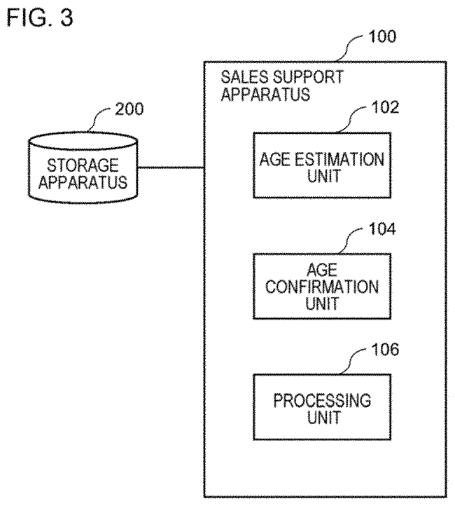

FIG. 3 is a functional block diagram logically illustrating a configuration of the sales support apparatus 100 according to the present example embodiment. Each component of the sales support apparatus 100 according to the present example embodiment in FIG. 3 is achieved by any combination of hardware and software of the computer 1000 in FIG. 2. Then, it is appreciated by a person skilled in the art that there are a variety of modified examples of a method and an apparatus for the achievement. A functional block diagram illustrating the sales support apparatus 100 according to each example embodiment described below illustrates not a configuration on a hardware basis but a block on a logical function basis.

The sales support apparatus 100 includes the age estimation unit 102, the age confirmation unit 104, the processing unit 106, and the storage apparatus 200. The age estimation unit 102 acquires a face image capturing a face of a person (e.g., the customer C) being in front of the equipment 7 in which the specific product 22 is displayed, and executes age estimation of the person (the customer C) by use of the face image. When a result of the age estimation by the age estimation unit 102 does not satisfy a criterion, the age confirmation unit 104 requests the person for age certification information, and determines whether the acquired age certification information satisfies a criterion. When a result of the determination by the age confirmation unit 104 satisfies a criterion, the processing unit 106 allows the specific product 22 to be taken out of the equipment 7, and also registers the face image as a master face image, together with the age certification information, in the storage apparatus 200 for subsequent occasions of authentication.

The age estimation unit 102 acquires a face image of the customer C captured by the camera 5, transmits the face image to an image analysis apparatus (not illustrated), causes the image analysis apparatus to execute age estimation, and receives an estimation result from the image analysis apparatus.

An age estimated by the age estimation unit 102 may have a range. For example, a range may be an age group such as an age group of ages from 16 to 19 or from 20 to 30, or may be a specific numerical value such as an age of 18 or 35.

A “criterion” used by the age confirmation unit 104 for determination is, for example, that a result of age estimation is equal to or more than an age to which selling of the specific product 22 is not permitted, e.g., “equal to or more than an age of 20”. A “criterion” varies in such a way as “equal to or more than an age of 21”, “equal to or more than an age of 18”, or “equal to or more than an age of 3”, according to a kind or sale area of the specific product 22, and a “criterion” may be changeable by suitably accepting setting. A “criterion” may be settable for each kind of the specific product 22.

Age certification information includes, for example, various pieces of information read from an identification card with a face photograph, such as a driver's license or a national identification number card of the customer C. The age confirmation unit 104 causes, for example, the identification card of the customer C to be captured by use of the camera 5 or the portable terminal 30, and acquires an image of the identification card. As described above, an application is previously installed in the portable terminal 30, and the application is activated. The application may cause the customer C to perform capturing with a camera of the portable terminal 30, and a generated image may be transmitted from the portable terminal 30 to the sales support apparatus 100.

Age certification information may be an image generated by capturing an identification card. Age certification information may include a face photograph of the customer C extracted from the image, a feature value extracted from the face photograph of the customer C, or the like. Further, age certification information may include a birth date of the customer C read from the image by an optical character reader (OCR) or the like. Alternatively, age certification information may include information indicating whether an age computed from the birth date of the customer C or an age of the customer C is an age to which selling of the specific product 22 can be permitted, or the like.

In the processing unit 106, “allowing the specific product 22 to be taken out of the equipment 7” may be controlling by the sales support apparatus 100 in such a way as to open a door of the equipment 7, may be unlocking a key of a door locked by the key that restricts opening and closing of the door, or may be releasing of gripping by a mechanism that grips the specific product 22.

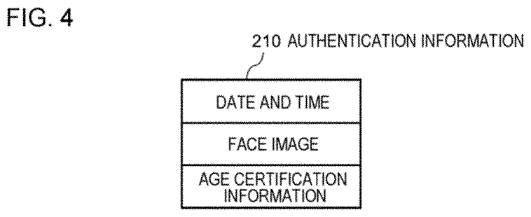

FIG. 4 is a diagram illustrating one example of a data structure of authentication information 210. The authentication information 210 associates at least a face image of the customer C with age certification information. Further, the authentication information 210 may associate a date and time. A date and time to be associated is, for example, at least one of a date and time when the customer C visits a store, a date and time when a face image of the customer C is captured, a date and time when age certification information is acquired, a date and time when a record of the authentication information 210 is stored in the storage apparatus 200, and the like.

A face image to be registered in the authentication information 210 may be a feature value of a face. A master face image is registered in the storage apparatus 200 by the processing unit 106, for subsequent occasions of authentication by the age confirmation unit 104. The subsequent occasion is a time when the customer C is once allowed to take the specific product 22 out of the equipment 7, takes out the specific product 22, and thereafter attempts to take the specific product 22 out of the equipment 7 again.

However, in order to take the specific product 22 out of the equipment 7 after the specific product 22 is allowed to be taken out of the equipment 7, a door of the equipment 7, for example, may be unlocked, the door may be opened, but then, the specific product 22 may not be taken out actually. In other words, there may be such a case that, after a door is unlocked, the customer C opens the door of the equipment 7, sees a product, but gives up purchase of the specific product 22, closes the door without taking the specific product 22 out of the equipment 7, and the door is locked. Thereafter, when the customer C attempts to take the specific product 22 out of the equipment 7 again, authentication is needed.

Moreover, until subsequent occasions, the customer C may go out of a store, or may remain in the store. This may be after payment processing of another product is finished, or may be before payment processing is performed.

### <Operation Example>

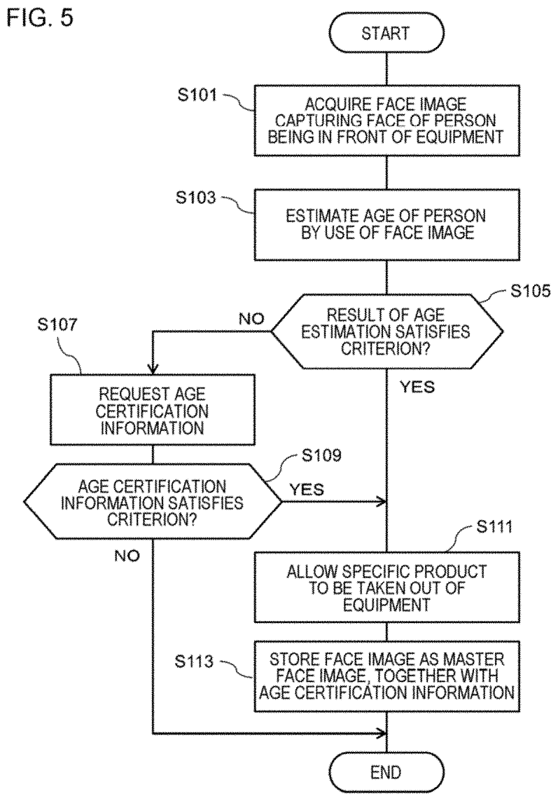

FIG. 5 is a flowchart illustrating an operation example of the sales support apparatus 100 according to the present example embodiment.

The age estimation unit 102 acquires a face image capturing a face of a person (e.g., the customer C) being in front of the equipment 7 in which the specific product 22 is displayed (step S101). The age confirmation unit 104 executes age estimation of the person (the customer C) by use of the face image (step S103). When a result of the age estimation by the age estimation unit 102 does not satisfy a criterion (NO in step S105), the age confirmation unit 104 requests the person for age certification information (step S107), and determines whether the acquired age certification information satisfies a criterion (step S109). When a result of the determination by the age confirmation unit 104 satisfies a criterion (YES in step S109), the processing unit 106 allows the specific product 22 to be taken out of the equipment 7 (step S111), and also registers the face image as a master face image, together with the age certification information, in the storage apparatus 200 for subsequent occasions of authentication (step S113). Then, the present processing is finished.

On the other hand, when a result of the age estimation by the age estimation unit 102 satisfies the criterion in step S105 (YES in step S105), an advance is made to step S111. Moreover, when a result of the determination by the age confirmation unit 104 does not satisfy the criterion in step S109 (NO in step S109), steps S111 and S113 are bypassed, and the present processing is finished. In other words, when an estimated age does not satisfy the criterion in step S109 (NO in step S109), the customer C cannot take the specific product 22 out of the equipment 7.

In the processing of step S103 described above, for example, capture by the camera 5 is automatically started when the customer C stands in front of the equipment 7 in which the specific product 22 is displayed, and age estimation is executed. In other words, the customer C is not conscious that age estimation processing is performed. However, capture by the camera 5 may not be started when the customer C stands in front of the equipment 7, but a range in which a person standing in front of the equipment 7 is captured may be constantly captured.

A front of the equipment 7 includes a place where the customer C can see the specific product 22 displayed in the equipment 7, a place to approach the equipment 7 and stand in order to take the specific product 22 out of the equipment 7, a place for performing an operation or the like for taking the specific product 22 out of the equipment 7, and the like.

According to the present example embodiment, when a result of age estimation by the age estimation unit 102 satisfies a criterion, the specific product 22 is allowed to be taken out of the equipment 7, and, therefore, convenience of a customer when a specific product is sold is improved, in an unmanned or labor-saving store. Further, when a result of the age estimation by the age estimation unit 102 does not satisfy a criterion, the customer C is requested for age certification information, age confirmation is performed, and, therefore, selling of the specific product 22 can be performed properly. Furthermore, the processing unit 106 registers a face image of the customer C who has been allowed to take the specific product 22, as a master face image in the storage apparatus 200. Thus, when the customer C stands in front of the equipment 7, and attempts to take the specific product 22 again, subsequent authentication processing can be not performed, because the master face image is already saved. This further improves convenience of the customer C.

### Second Example Embodiment

Except for including a configuration that dispenses with an age certification procedure of a customer C when having already taken a specific product 22 out of equipment 7 of the specific product 22, and then attempting to take the specific product 22 out of the equipment 7 again, a sales support apparatus 100 according to the present example embodiment is similar to that according to the example embodiment described above. A description is given below by use of a functional block diagram in FIG. 3 according to the first example embodiment. However, the configuration according to the present example embodiment may be combined with at least one of configurations according to other example embodiments to a consistent degree.

### <Functional Configuration Example>

A processing unit 106 accesses a storage apparatus 200 when a result of age estimation does not satisfy a criterion, and allows the specific product 22 to be taken out of the equipment 7 when a master face image corresponding to a face image is registered together with age certification information.

### <Operation Example>

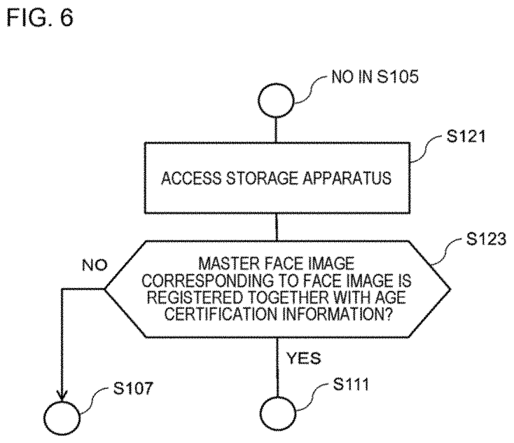

FIG. 6 is a flowchart illustrating one example of processing when a result of age estimation does not satisfy a criterion in determination in step S105 in FIG. 5.

In step S105 in FIG. 5, when a result of age estimation does not satisfy a criterion (NO in step S105), the processing unit 106 accesses the storage apparatus 200 (step S121 in FIG. 6). Then, when a master face image corresponding to a face image is registered together with age certification information (YES in step S123), the processing unit 106 advances to step S111 in FIG. 5, and allows the specific product 22 to be taken out of the equipment 7 (step S111). In other words, authentication processing of age certification information in steps S107 to S109 can be bypassed. Moreover, in this case, step S113 after step S111 may be not performed, and processing may be finished.

On the other hand, when a master face image corresponding to a face image is not registered together with age certification information (NO in step S123), the processing unit 106 advances to step S107 in FIG. 5, and requests the customer C for age certification information. Subsequent processing is similar to that according to the first example embodiment.

In steps S107 to S109, the customer C needs to perform, for example, an operation in which the customer C takes out an identification card, captures the identification card by use of a portable terminal 30, and transmits to the sales support apparatus 100, and this work is troublesome to the customer C.

According to the present example embodiment, an advantageous effect similar to that of the example embodiment described above is provided, also the processing unit 106 allows the specific product 22 to be taken out of the equipment 7 without requesting age certification information when a master face image is already registered in the storage apparatus 200, therefore, a troublesome procedure becomes unnecessary, and convenience of the customer C improves.

### Third Example Embodiment

### <Functional Configuration Example>

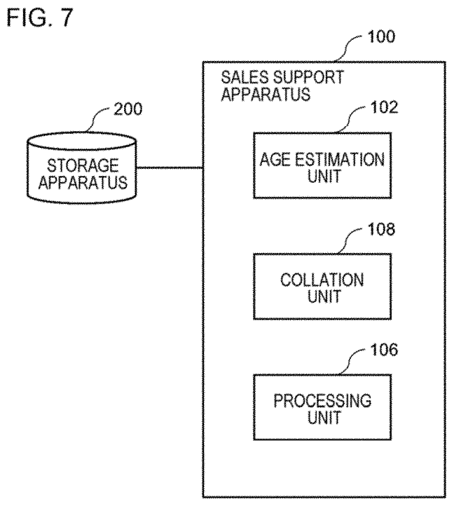

FIG. 7 is a functional block diagram illustrating a logical configuration example of a sales support apparatus 100 according to an example embodiment of the present invention. In the example embodiments described above, when a customer C stands in front of equipment 7 in which a specific product 22 is displayed, age estimation of the customer C is executed. The sales support apparatus 100 according to the present example embodiment differs from that according to the example embodiments described above in that age estimation is executed when the customer C enters a store 10 as well. However, the sales support apparatus 100 according to the present example embodiment may be combined with at least one of configurations according to other example embodiments to a consistent degree.

The sales support apparatus 100 includes an age estimation unit 102, a processing unit 106, a collation unit 108, and the storage apparatus 200.

When a person enters a store, the age estimation unit 102 acquires a face image capturing a face of the person, and executes age estimation by use of the face image. The processing unit 106 registers the face image in the storage apparatus 200 as a master face image, in a state where whether a result of the age estimation satisfies a criterion is determinable. When a person stands in front of the equipment 7 in which the specific product 22 is displayed, the collation unit 108 acquires a collation target face image capturing a face of the person being in front of the equipment 7, and collates the acquired collation target face image with the master face image registered in the storage apparatus 200. When the master face image corresponding to the collation target face image is present in the storage apparatus 200, and an estimated age satisfies a criterion, the processing unit 106 allows the specific product 22 to be taken out of the equipment 7. When the master face image corresponding to the collation target face image is not present in the storage apparatus 200 according to the collation unit 108, the age estimation unit 102 executes age estimation by use of the collation target face image. When a result of the age estimation satisfies the criterion, the processing unit 106 allows the specific product 22 to be taken out of the equipment 7, and also registers the collation target face image as the master face image, together with a result of the age estimation, in the storage apparatus 200.

According to the present example embodiment, in order to execute age estimation of the customer C when the customer C enters the store 10, a camera 5 may be placed at an entrance of the store 10 as well. Alternatively, the camera 5 includes, in a capture range, both the entrance of the store 10 and a front of the equipment 7 in which the specific product 22 is displayed.

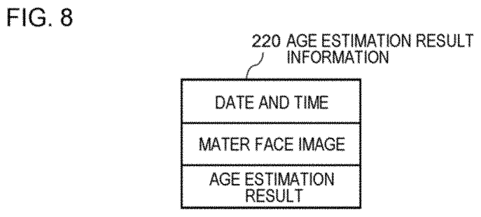

FIG. 8 is a diagram illustrating one example of a data structure of age estimation result information 220. The age estimation result information 220 associates at least a master face image of the customer C with an age estimation result. Further, the age estimation result information 220 may associate a date and time. A date and time to be associated is, for example, at least one of a date and time when the customer C visits a store, a date and time when a face image of the customer C is captured, a date and time when age estimation is performed (an age estimation result is acquired), a date and time when a record of the age estimation result information 220 is stored in the storage apparatus 200, and the like.

A master face image to be registered in the age estimation result information 220 may be a feature value of a face. After age estimation by the age estimation unit 102 is executed, the age estimation result information 220 is stored in the storage apparatus 200 by the processing unit 106 in such a way that a face image of the customer C used for the age estimation is associated with a result of the age estimation.

Herein, storing in the storage apparatus 200 in a state where whether a result of age estimation satisfies a criterion is determinable is storing the following age estimation result information 220 in the storage apparatus 200. For example, the age estimation result information 220 includes information about whether an estimated age of the customer C satisfies a criterion of age restriction of the specific product 22, or information indicating the estimated age itself. Information about whether an age of the customer C satisfies a criterion of age restriction of the specific product 22 may include, for example, information indicating whether an age of the customer C is equal to or more than or is less than a criterion age, information indicating whether the customer C is a grownup or a minor, information indicating whether the specific product 22 is sellable or unsellable to the customer C, and the like. Information indicating an estimated age of the customer C may include, for example, information indicating a specific age (an age of 35), information indicating a range of ages (equal to or more than an age of 20, ages of 15 to 18, and the like), information indicating an age group (forties or the like), and the like.

### <Operation Example>

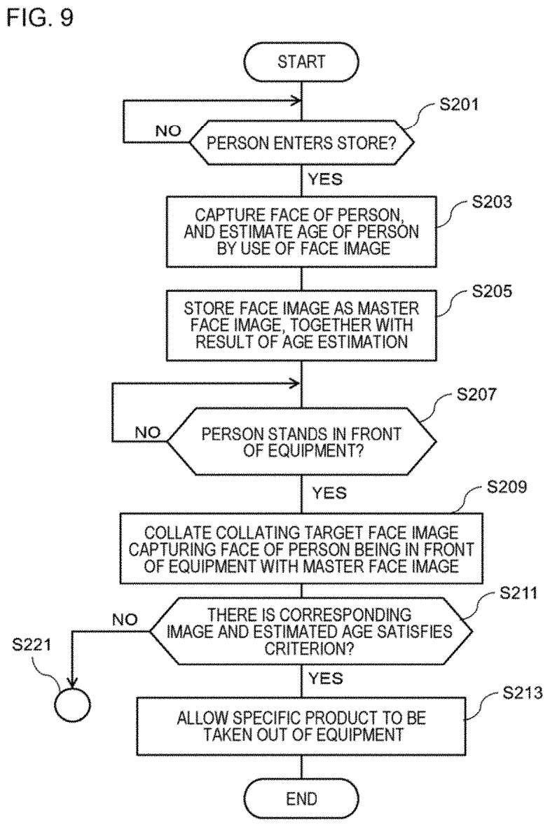

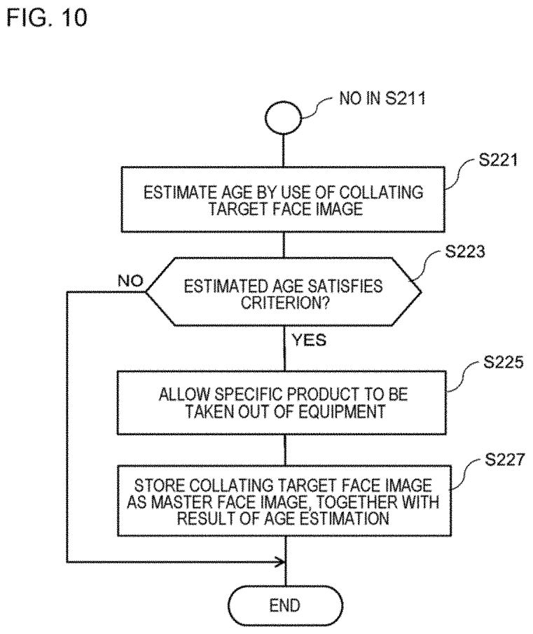

FIGS. 9 and 10 are flowcharts illustrating one example of an operation of the sales support apparatus 100.

First, when a person enters a store (YES in step S201), the age estimation unit 102 acquires a face image capturing a face of the person, and executes age estimation by use of the face image (step S203). Herein, the age estimation unit 102 acquires a face image captured by the camera 5. The processing unit 106 registers the face image in the storage apparatus 200 as a master face image, in a state where whether a result of the age estimation satisfies a criterion is determinable (step S205).

Next, when a person stands in front of the equipment 7 in which the specific product 22 is displayed (YES in step S207), the collation unit 108 acquires a collation target face image capturing a face of the person being in front of the equipment 7, and collates the collation target face image with the master face image registered in the storage apparatus 200 (step S209).

Herein, the collation unit 108 acquires a face image captured by the camera 5. When a master face image corresponding to the collation target face image is present in the storage apparatus 200, and an estimated age satisfies a criterion (YES in step S211), the processing unit 106 allows the specific product 22 to be taken out of the equipment 7 (step S213). Then, the present processing is finished.

In step S211, the collation unit 108 refers to the age estimation result information 220, and finds, for example, a master face image of which a similarity degree to the collation target face image is equal to or more than a predetermined threshold value. Then, the collation unit 108 reads an age estimation result being associated with the master face image. Then, the collation unit 108 determines, based on the age estimation result, whether an estimated age of the customer C satisfies a criterion.

On the other hand, when a master face image corresponding to the collation target face image is not present in the storage apparatus 200 according to the collation unit 108 (NO in step S211), an advance is made to step S221 in FIG. 10. The age estimation unit 102 executes age estimation by use of the collation target face image acquired in step S209 (step S221). When a result of the age estimation satisfies the criterion (YES in step S223), the processing unit 106 allows the specific product 22 to be taken out of the equipment 7 (step S225), and also registers the collation target face image as the master face image, together with a result of the age estimation, in the storage apparatus 200 (step S227). Then, the present processing is finished.

Further, when an estimated age does not satisfy the criterion in step S223 (NO in step S223), steps S225 and S227 are bypassed, and the present processing is finished. In other words, when an estimated age does not satisfy the criterion in step S223 (NO in step S223), the customer C cannot take the specific product 22 out of the equipment 7.

Further, in the present example embodiment, the sales support apparatus 100 may include an age confirmation unit 104 according to the example embodiments described above. In this case, as in the example embodiments described above, when an estimated age does not satisfy the criterion in step S223 (NO in step S223), the age confirmation unit 104 may request age certification information, and determination processing of whether the acquired age certification information satisfies a criterion may be performed.

According to the present example embodiment, an advantageous effect similar to that of the example embodiments described above is provided, further, the specific product 22 is allowed to be taken out of the equipment 7 without performing age determination in front of the equipment 7 when an estimated age satisfies a criterion in age estimation processing at entrance into a store, and, therefore, convenience of the customer C improves.

### Fourth Example Embodiment

### <Functional Configuration Example>

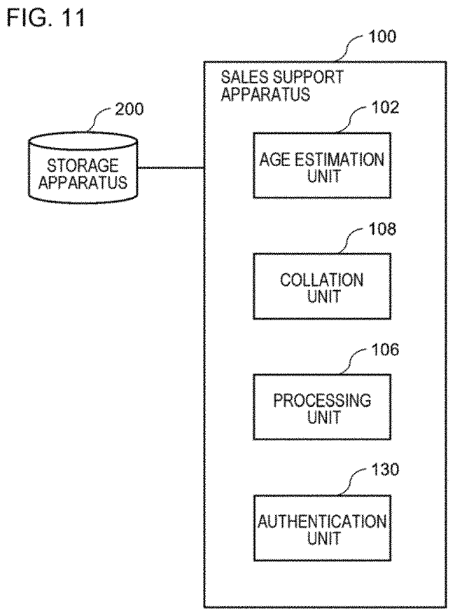

FIG. 11 is a functional block diagram illustrating a logical configuration example of a sales support apparatus 100 according to an example embodiment of the present invention. Except for including a configuration that confirms, before registering a face image of a customer

C in a storage apparatus 200, that the face image of the customer C is not a photograph or the like, but a real person exists there, the sales support apparatus 100 according to the present example embodiment is similar to that according to the example embodiments described above. The sales support apparatus 100 according to the present example embodiment includes the same configuration as that according to the third example embodiment in FIG. 7, and further includes an authentication unit 130. However, the configuration according to the present example embodiment may be combined with at least one of configurations according to other example embodiments to a consistent degree.

The authentication unit 130 performs iris authentication or liveness determination of a person, before performing registration of a master face image in the storage apparatus 200.

In a case of iris authentication, the authentication unit 130 captures, by use of a camera (not illustrated) for iris capture, for example, an iris of the customer C at entrance into a store, and registers an image or a feature value of the iris as a to-be-authenticated iris image, further in association with the master face image, in age estimation result information 220.

Then, before performing registration of a master face image in the storage apparatus 200, the authentication unit 130 captures an iris of the customer C by use of a camera (not illustrated) for iris capture, transmits a to-be-authenticated iris image to an iris authentication apparatus (not illustrated), and also transmits, to the iris authentication apparatus, a master iris image or a feature value thereof registered in the age estimation result information 220 in association with the master face image. The iris authentication apparatus collates a received to-be-authenticated iris image with the master iris image, and returns an authentication result to the sales support apparatus 100. The authentication unit 130 receives the authentication result from the iris authentication apparatus.

In a case of liveness determination, the authentication unit 130 acquires, for example, a moving image captured by a camera 5 at entrance into a store, acquires, for example, a feature of blinking, gaze, motion of a lip, or the like of the customer C, and registers the acquired feature in the age estimation result information 220 as a to-be-authenticated feature value, further in association with the master face image.

Then, before performing registration of a master face image in the storage apparatus 200, the authentication unit 130 acquires a moving image captured by the camera 5, acquires, for example, a feature of blinking, gaze, motion of a lip, or the like of the customer C, transmits a to-be-authenticated feature value to an image analysis apparatus (not illustrated), and also transmits, to the image analysis apparatus, a master feature value registered in the age estimation result information 220 in association with the master face image. The image analysis apparatus collates the received to-be-authenticated feature value with the master face image, and returns an authentication result to the sales support apparatus 100. The authentication unit 130 receives the authentication result from the image analysis apparatus.

### <Operation Example>

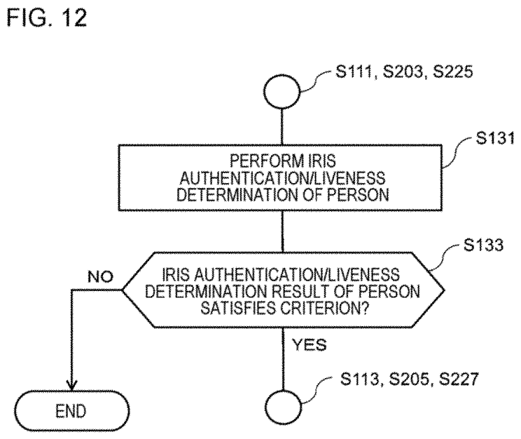

FIG. 12 is a flowchart illustrating one example of an operation of the sales support apparatus 100. The flowchart in FIG. 12 is executed after processing in one of step S111 in FIG. 5, step S203 in FIG. 9, and step S225 in FIG. 10, i.e., before processing of registering a master face image in the storage apparatus 200 in one of step S113 in FIG. 5, step S205 in FIG. 9, and step S227 in FIG. 10.

After step S111 in FIG. 5, step S203 in FIG. 9, or step S225 in FIG. 10, the authentication unit 130 performs iris authentication or liveness determination of a person, before performing registration of a master face image in the storage apparatus 200 (step S113 in FIG. 5, step S205 in FIG. 9, or step S227 in FIG. 10) (step S131). Then, when a result of the iris authentication or liveness determination of the person satisfies a criterion (YES in step S133), an advance is made to step S113 in FIG. 5, step S205 in FIG. 9, or step S227 in FIG. 10, and processing of registering a master face image in the storage apparatus 200 is performed. On the other hand, when a result of the iris authentication or liveness determination of the person does not satisfy the criterion (NO in step S133), processing in step S113 in FIG. 5, step S205 in FIG. 9, or step S227 in FIG. 10 is not executed. In other words, the master face image of the customer C is not registered in the storage apparatus 200.

According to the present example embodiment, an advantageous effect similar to that of the example embodiments described above is provided, further, not a face photograph or the like but presence of the customer C himself/herself is confirmed before registration of a master face image, and, therefore, fraudulence can be prevented.

### Fifth Example Embodiment

### <Functional Configuration Example>

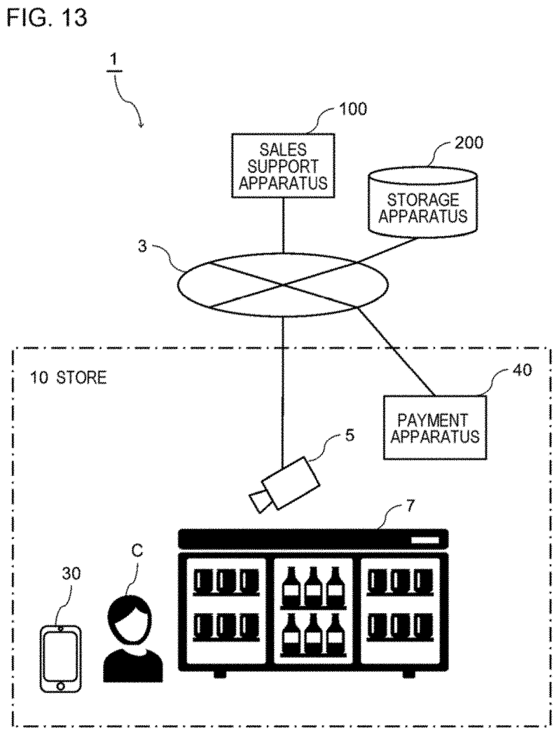

FIG. 13 is a diagram schematically illustrating a system configuration of a sales system 1 according to an example embodiment of the present invention. Except for further including a payment apparatus 40 in addition to the configuration of the sales system 1 in FIG. 1, the sales system 1 according to the present example embodiment is similar to the sales system 1 in FIG. 1. Moreover, since a sales support apparatus 100 according to the present example embodiment includes the same configuration as the sales support apparatus 100 in FIG. 11, a description is given by use of a functional block diagram in FIG. 11. However, the sales support apparatus 100 according to the present example embodiment may be combined with at least one of configurations according to other example embodiments to a consistent degree.

The payment apparatus 40 is, for example, a POS terminal or the like that performs registration processing and payment processing of a product to be purchased by a customer C. However, a configuration other than a configuration that performs product registration processing by a POS terminal is also conceivable, and the present invention is not particularly limited. For example, a configuration may be such that a product is determined when putting of the product in a shopping cart is sensed, and product registration processing is performed. Alternatively, a configuration may be such that an IC tag such as a radio frequency identification (RFID) having an IC chip recording a product code is attached to a product, and product registration processing is performed by reading the product code by an IC tag reader before arrival at the payment apparatus 40.

The payment apparatus 40 performs settlement processing of a product finished with product registration. A settlement means (cash, a credit card, electronic money, or the like) is not particularly limited.

A processing unit 106 registers, in a storage apparatus 200 in association with a master face image, already-visited information indicating a time after payment processing of a product to be purchased, a time after elapse of a certain time, or going out of a store once.

When the already-visited information is registered in the storage apparatus 200, an authentication unit 130 further performs iris authentication or liveness determination.

### <Operation Example>

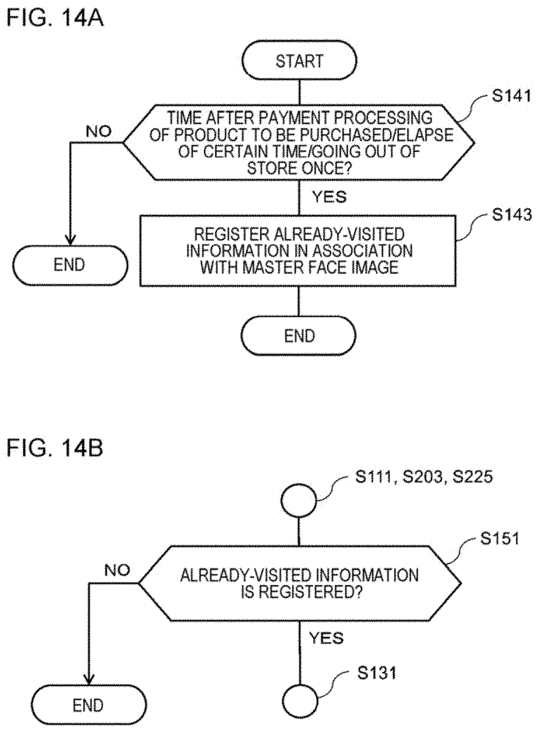

FIG. 14 is a flowchart illustrating one example of an operation of the sales support apparatus 100. FIG. 14(a) is a flowchart illustrating a processing procedure of registering already-visited information in association with a master face image. FIG. 14(b) is a flowchart illustrating a processing procedure according to presence or absence of the already-visited information.

In FIG. 14(a), when one of the following conditions is satisfied, an advance is made to step S143, and already-visited information is registered.
(a1) after payment processing of a product to be purchased of a customer C is finished by the payment apparatus 40
(a2) after payment processing is finished, and after a result of a certain time
(a3) after a specific product 22 is allowed to be taken out of equipment 7, and after elapse of a certain time
(a4) after a master face image of the customer C is registered in the storage apparatus 200, and after elapse of a certain time
(a5) when the customer C has gone out of a store

In a case of (a1) and (a2), the processing unit 106 acquires a face image of the customer C for whom payment processing is performed by the payment apparatus 40. In a case of (a5), the processing unit 106 acquires, for example, a face image of a person who has exited from an exit of a store 10. Then, in a case of (a1), (a2), and (a5), the acquired face image is collated with a master face image registered in the storage apparatus 200. Then, when a master face image with a similarity degree being equal to or more than a threshold value is found, already-visited information is registered in association with the master face image.

In a case of (a3) or (a4), when a master face image is registered after the specific product 22 is allowed to be taken out of the equipment 7, an elapsed time is monitored, and, when a certain time elapses, the master face image already-visited information is registered in association.

The flow in FIG. 14(b) is executed after processing in one of step S111 in FIG. 5, step S203 in FIG. 9, and step S225 in FIG. 10, i.e., before processing of registering a master face image in the storage apparatus 200 in one of step S113 in FIG. 5, step S205 in FIG. 9, and step S227 in FIG. 10.

When the already-visited information is registered in the storage apparatus 200 (YES in step S151), the authentication unit 130 advances to step S131 in FIG. 12, and further performs iris authentication or liveness determination. When a result of the authentication satisfies a criterion, an advance is made to one of step S113 in FIG. 5, step S205 in FIG. 9, and step S227 in FIG. 10, and a master face image is registered in the storage apparatus 200.

According to the present example embodiment, an advantageous effect similar to that of the example embodiments described above is provided, and, further, when the customer C goes out of a store once and then returns to the store 10, or when the customer C attempts to take the specific product 22 out of the equipment 7 again after finishing with payment processing or after once taking the specific product 22 out of the equipment 7, the customer C is not requested for age certification information again, and a fraudulent act such as authentication using a photograph or the like can be prevented.

### Sixth Example Embodiment

### <Functional Configuration Example>

Except for further including a configuration that erases a master face image registered in a storage apparatus 200 when a predetermined condition is satisfied, a sales support apparatus 100 according to the present example embodiment is same as that according to the example embodiments described above. In the present example embodiment, a description is given by use of a functional block diagram of the sales support apparatus 100 according to the third example embodiment in FIG. 7. However, the configuration according to the present example embodiment may be combined with at least one of configurations according to other example embodiments to a consistent degree.

### <Functional Configuration Example>

When one of the following conditions is satisfied, a processing unit 106 erases a master face image of a customer C from the storage apparatus 200.
(b1) when performing of payment processing of a product to be purchased within the store is detected

Specifically, a notification that payment processing is finished is received from a payment apparatus 40.
(b2) when a person going out of a store is detected Specifically, a camera 5 performs tracking of the customer C within a store 10 by image analysis processing, and the customer C going out of the store 10 is detected.
(b3) when a certain time elapses after a master face image is registered in the storage apparatus 200

Specifically, after a master face image is registered in the storage apparatus 200, the processing unit 106 monitors elapse of a certain time.

### <Operation Example>

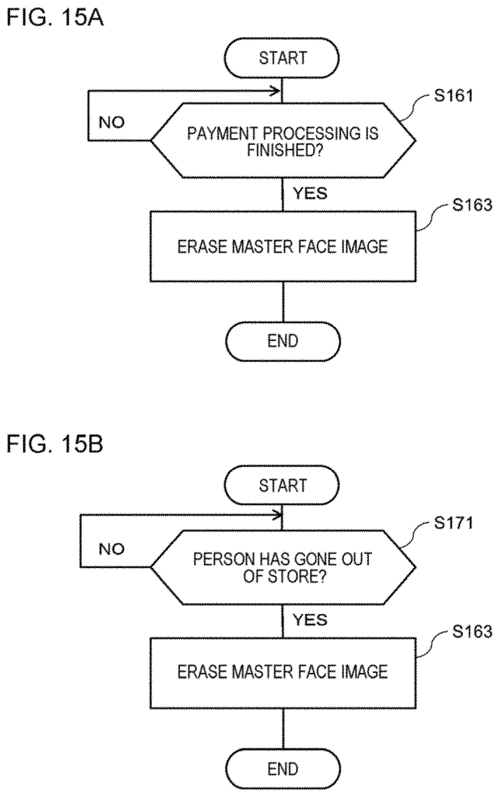

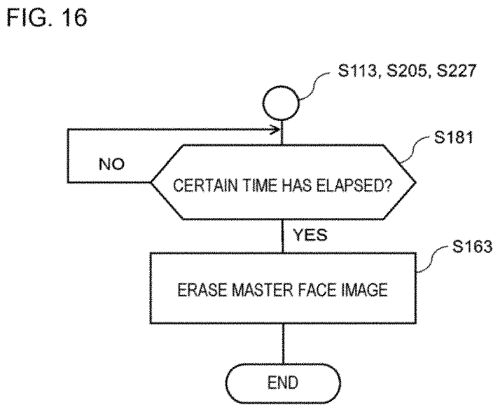

FIGS. 15 and 16 are flowcharts illustrating an operation example of the sales support apparatus 100.

In the example of FIG. 15(a), the processing unit 106 determines whether payment processing of a product to be purchased within the store is finished (step S161). For example, when a notification that payment processing is finished is received from the payment apparatus 40 (YES in step S161), the processing unit 106 erases a master face image of the customer C from the storage apparatus 200 (step S163).

In the example of FIG. 15(b), whether a person has gone out of the store 10 is determined (step S171). For example, when the customer C going out of the store 10 is detected by tracking of the customer C by the camera 5 (YES in step S171), the processing unit 106 erases a master face image of the customer C from the storage apparatus 200 (step S163).

In the example of FIG. 16, the present processing is executed after processing of registering a master face image in the storage apparatus 200 is performed in one of step S113 in FIG. 5, step S205 in FIG. 9, and step S227 in FIG. 10. After processing of registering a master face image in the storage apparatus 200 is performed in one of step S113 in FIG. 5, step S205 in FIG. 9, and step S227 in FIG. 10, the processing unit 106 determines whether a certain time has elapsed (step S181). Then, when a certain time has elapsed (YES in step S181), the processing unit 106 erases a master face image of the customer C from the storage apparatus 200 (step S163).

According to the present example embodiment, an advantageous effect similar to that of the example embodiments described above is provided, and, further, personal information can be erased at an appropriate timing.

The example embodiments of the present invention have been described above with reference to the drawings, but are exemplifications of the present invention, and various configurations other than the above can also be adopted.

### <Acquisition of Age Certification Information by Identification Card>

For example, a specific example of an acquisition method (step S107 to step S109 in FIG. 5) of age certification information by an identification card in the example embodiments described above is described.

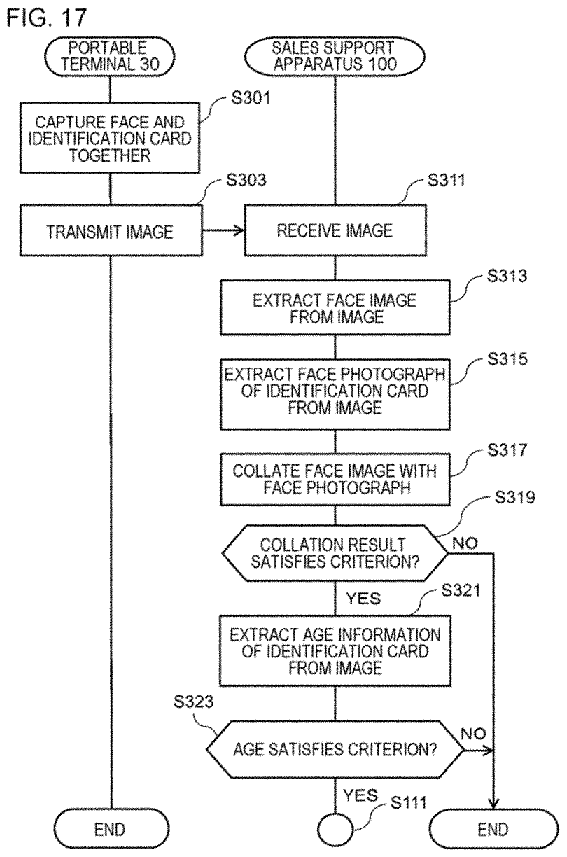

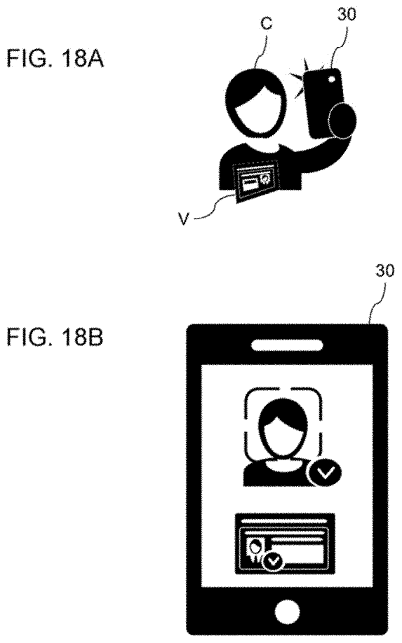

FIG. 17 is a flowchart illustrating an operation example of an acquisition procedure of age certification information. A description is given below by use of FIGS. 17 and 18.

First, in a portable terminal 30, an application is activated. The application achieves a part of a function of an age confirmation unit 104. The age confirmation unit 104 instructs the customer C to capture in such a way that an identification card V and a face of the customer C are included in the same image.

The age confirmation unit 104 activates a camera of the portable terminal 30, and screen-displays, on a display of the portable terminal 30, for example, a message such as “please capture a photograph in such a way that a face and an identification card are included together.”, a capture view, a frame indicating a capture region, and a capture button.

The customer C captures, by use of the portable terminal 30, in such a way that the identification card V and the face of the customer C are included in the same image, as illustrated in FIG. 18(a) (step S301). A message instructing the customer C to include, in a capture range, at least a photograph illustrated in the identification card, and a birth date may be output (voice or display). Alternatively, a message instructing the customer C to capture both a front surface and a back surface of the identification card in turn may be output (voice or display).

The portable terminal 30 acquires the captured image, and transmits the acquired image to the sales support apparatus 100 (step S303).

In the sales support apparatus 100, when the age confirmation unit 104 receives the image transmitted from the portable terminal 30 (step S311), the age confirmation unit 104 performs processing in and after step S313. Specifically, the age confirmation unit 104 first extracts a face image of the customer C from the received image (step S313). Further, the age confirmation unit 104 extracts a region of a face photograph of the identification card from the received image (step S315). Then, the age confirmation unit 104 collates the face image extracted in step S313 with the face photograph extracted in step S315 and an image (step S317).

When a collation result of the two images satisfies a criterion (YES in step S319), the age confirmation unit 104 further advances to step S321. For example, it may be assumed that, when a similarity degree of two images is equal to or more than a threshold value as a result of collation, a criterion is satisfied. When the criterion is not satisfied (NO in step S319), the present processing is finished. For example, FIG. 18(b) is an example of a screen of the portable terminal 30 indicating that a face image corresponds to a photograph of an identification card.

The age confirmation unit 104 further extracts a region image of the age certification information (a birth date) of the identification card from the image received in step S311, further converts, by OCR, birth date illustrated in the extracted image region into birth date data, and acquires the birth date data (step S321).

The age confirmation unit 104 determines whether the acquired birth date data satisfies a criterion (step S323). Specifically, an age of the customer C may be computed from the birth date data and a current date and time, and whether a criterion is satisfied may be determined, or a birth date to be a criterion age may be computed on a date, and whether acquisition means birth date data are before or after the birth date may be determined.

When the criterion is satisfied (YES in step S323), an advance is made to step S111 in FIG. 5. In step S111, the specific product 22 is allowed to be taken out of the equipment 7. On the other hand, when the criterion is not satisfied (NO in step S323), processing is finished. In other words, since the specific product 22 is not allowed to be taken out of the equipment 7, the customer C cannot purchase the specific product 22.

However, orders of processing in steps S313 to 5319 and processing in steps S321 to S323 may be interchanged.

According to this configuration, age certification information of the customer C can be easily acquired by causing the customer C to operate the portable terminal 30.

### <Opening and Closing of Door of Equipment by Bar Code Utilization>

In another example embodiment, a configuration example of opening and closing of a door of the equipment 7 by a bar code displayed on the portable terminal 30 is described. This configuration is an example in which processing in steps S209 to S213 is achieved by an application of the portable terminal 30 when the customer C stands in front of the equipment 7 of the specific product 22 in step S207 in FIG. 9.

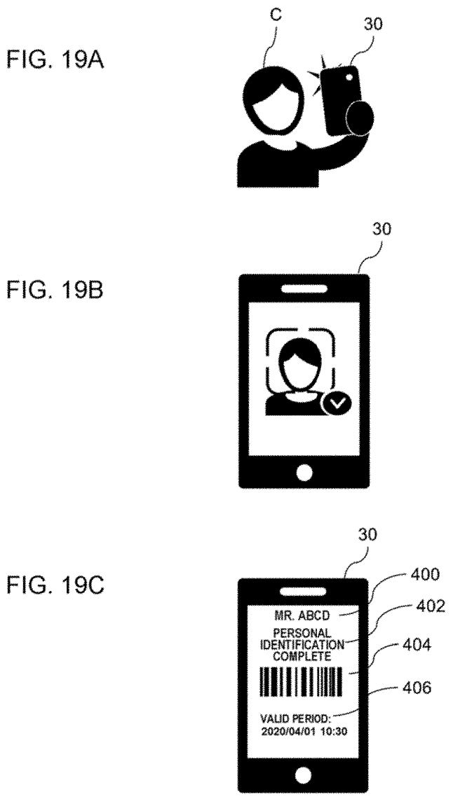

For example, in step S209 in FIG. 9, a collation unit 108 causes the customer C to capture a face by use of the portable terminal 30 (FIG. 19(a)). An image captured by the portable terminal 30 is transmitted to the sales support apparatus 100, and the collation unit 108 acquires a collation target face image from the portable terminal 30. Then, the collation unit 108 collates the collation target face image with a master face image registered in the storage apparatus 200 (step S209 in FIG. 9).

When a master face image corresponding to the collation target face image is present in the storage apparatus 200, and an estimated age satisfies a criterion (YES in step S211) (FIG. 19(b)), the processing unit 106 allows the specific product 22 to be taken out of the equipment 7 (step S213). In this instance, the processing unit 106 displays, on the portable terminal 30, a screen 400 indicating that personal identification is completed. The screen 400 includes a display portion 402 of information indicating that personal identification is completed, a display portion 404 of a bar code recording key information for allowing the specific product 22 to be taken out of the equipment 7, and a display portion 406 of a valid period of the bar code.

However, a bar code may be another two-dimensional code, or may be a QR code (registered trademark).

For example, a code reader (not illustrated) is placed in the equipment 7, the customer C holds a bar code displayed on the portable terminal 30 over the code reader of the equipment 7, and, thereby, the code reader reads key information from the bar code. Processing of allowing the specific product 22 to be taken out of the equipment 7, such as unlocking of the door of the equipment 7, is performed by the key information read by the code reader of the equipment 7.

The bar code becomes invalid when, for example, a valid period passes. For example, the bar code is erased. Moreover, the bar code may be usable for payment processing in a payment apparatus 40. For example, a bar code may include information of a credit card used for payment by the customer C, and the like. Alternatively, a bar code for so-called QR code payment may include key information that allows the specific product 22 to be taken out of the equipment 7.

While the invention of the present application has been described above with reference to the example embodiments and examples, the invention of the present application is not limited to the example embodiments and examples described above. Various modifications understandable to a person skilled in the art can be made to a configuration and details of the invention of the present application within the scope of the invention of the present application.

Note that, when information relating to a user is acquired and utilized in the present invention, the acquisition and utilization are to be performed legally.

Some or all of the above-described example embodiments can also be described as, but are not limited to, the following supplementary notes.
1. A sales support apparatus including:

an age estimation unit; an age confirmation unit; a processing unit; and a storage unit, wherein

the age estimation unit acquires a face image capturing a face of a person being in front of equipment in which a specific product is displayed, and executes age estimation of the person by use of the face image,

when a result of the age estimation by the age estimation unit does not satisfy a criterion, the age confirmation unit requests the person for age certification information, and determines whether the acquired age certification information satisfies a criterion, and, when a result of the determination by the age confirmation unit satisfies a criterion, the processing unit allows the specific product to be taken out of the equipment, and registers the face image as a master face image, together with the age certification information, in the storage unit for subsequent occasions of authentication.
2. The sales support apparatus according to supplementary note 1, wherein

the processing unit accesses the storage unit when a result of the age estimation does not satisfy the criterion, and allows the specific product to be taken out of the equipment when the master face image corresponding to the face image is registered together with the age certification information.
3. A sales support apparatus including:

an age estimation unit; a processing unit; a collation unit; and a storage unit; wherein

when a person enters a store, the age estimation unit acquires a face image capturing a face of the person, and executes age estimation by use of the face image,

the processing unit registers the face image in the storage unit as a master face image, in a state where whether a result of the age estimation satisfies a criterion is determinable,

when a person stands in front of equipment in which a specific product is displayed, the collation unit acquires a collation target face image capturing a face of the person being in front of the equipment, and collates the acquired collation target face image with the master face image registered in the storage unit,

when the master face image corresponding to the collation target face image is present in the storage unit, and a result of the age estimation satisfies a criterion, the processing unit allows the specific product to be taken out of the equipment,

when the master face image corresponding to the collation target face image is not present in the storage unit according to the collation unit, the age estimation unit executes age estimation by use of the collation target face image, and,

when the result of the age estimation satisfies the criterion, the processing unit allows the specific product to be taken out of the equipment, and registers the collation target face image as the master face image, together with the result of the age estimation, in the storage unit.
4. The sales support apparatus according to any one of supplementary notes 1 to 3, further including

an authentication unit that performs iris authentication or liveness determination of the person, before performing registration of the master face image in the storage unit.
5. The sales support apparatus according to supplementary note 4, wherein

the processing unit registers, in the storage unit in association with the master face image, already-visited information indicating a time after payment processing of a product to be purchased, a time after elapse of a certain time, or going out of a store once, and,

when the already-visited information is registered in the storage unit, the authentication unit further performs the iris authentication or the liveness determination.
6. The sales support apparatus according to any one of supplementary notes 1 to 4, wherein

when performing of payment processing of a product to be purchased within the store is detected, the processing unit erases the master face image from the storage unit.
7. The sales support apparatus according to any one of supplementary notes 1 to 4, wherein

when the person going out of the store is detected, the processing unit erases the master face image from the storage unit.
8. The sales support apparatus according to any one of supplementary notes 1 to 7, wherein

when a certain time elapses after the master face image is registered in the storage unit, the processing unit erases the master face image from the storage unit.
9. A sales system including:

equipment that displays a specific product; and

a sales support apparatus, wherein

the sales support apparatus includes

an age estimation unit, an age confirmation unit, a processing unit, and a storage unit,

the age estimation unit acquires a face image capturing a face of a person being in front of equipment in which a specific product is displayed, and executes age estimation of the person by use of the face image,

when a result of the age estimation by the age estimation unit does not satisfy a criterion, the age confirmation unit requests the person for age certification information, and determines whether the acquired age certification information satisfies a criterion, and,

when a result of the determination by the age confirmation unit satisfies a criterion, the processing unit allows the specific product to be taken out of the equipment, and registers the face image as a master face image, together with the age certification information, in the storage unit for subsequent occasions of authentication.
10. The sales system according to supplementary note 9, wherein

in the sales support apparatus,

the processing unit accesses the storage unit when a result of the age estimation does not satisfy the criterion, and allows the specific product to be taken out of the equipment when the master face image corresponding to the face image is registered together with the age certification information.
11. A sales system including:

equipment that displays a specific product; and

a sales support apparatus, wherein

the sales support apparatus includes

an age estimation unit, a processing unit, a collation unit, and a storage unit,

when a person enters a store, the age estimation unit acquires a face image capturing a face of the person, and executes age estimation by use of the face image,

the processing unit registers the face image in the storage unit as a master face image, in a state where whether a result of the age estimation satisfies a criterion is determinable,

when a person stands in front of equipment in which a specific product is displayed, the collation unit acquires a collation target face image capturing a face of the person being in front of the equipment, and collates the acquired collation target face image with the master face image registered in the storage unit,

when the master face image corresponding to the collation target face image is present in the storage unit, and a result of the age estimation satisfies a criterion, the processing unit allows the specific product to be taken out of the equipment,

when the master face image corresponding to the collation target face image is not present in the storage unit according to the collation unit, the age estimation unit executes age estimation by use of the collation target face image, and,

when the result of the age estimation satisfies the criterion, the processing unit allows the specific product to be taken out of the equipment, and registers the collation target face image as the master face image, together with the result of the age estimation, in the storage unit.
12. The sales system according to any one of supplementary notes 9 to 11, further including

an authentication unit that performs iris authentication or liveness determination of the person, before performing registration of the master face image in the storage unit.
13. The sales system according to supplementary note 12, wherein

in the sales support apparatus,

the processing unit registers, in the storage unit in association with the master face image, already-visited information indicating a time after payment processing of a product to be purchased, a time after elapse of a certain time, or going out of a store once, and,

when the already-visited information is registered in the storage unit, the authentication unit further performs the iris authentication or the liveness determination.
14. The sales system according to any one of supplementary notes 9 to 12, wherein

in the sales support apparatus,

when performing of payment processing of a product to be purchased within the store is detected, the processing unit erases the master face image from the storage unit.
15. The sales system according to any one of supplementary notes 9 to 12, wherein

in the sales support apparatus,

when the person going out of the store is detected, the processing unit erases the master face image from the storage unit.
16. The sales system according to any one of supplementary notes 9 to 15, wherein

in the sales support apparatus,

when a certain time elapses after the master face image is registered in the storage unit, the processing unit erases the master face image from the storage unit.
17. A sales support method including,

by a sales support apparatus:

acquiring a face image capturing a face of a person being in front of equipment in which a specific product is displayed, and executing age estimation of the person by use of the face image;

when a result of the age estimation does not satisfy a criterion, requesting the person for age certification information, and determining whether the acquired age certification information satisfies a criterion; and,

when a result of the determination satisfies a criterion, allowing the specific product to be taken out of the equipment, and registering the face image as a master face image, together with the age certification information, in a storage unit for subsequent occasions of authentication.
18. The sales support method according to supplementary note 17, further including,

by the sales support apparatus,

accessing the storage unit when a result of the age estimation does not satisfy the criterion, and allowing the specific product to be taken out of the equipment when the master face image corresponding to the face image is registered together with the age certification information.
19. A sales support method including,

by a sales support apparatus:

when a person enters a store, acquiring a face image capturing a face of the person, and executing age estimation by use of the face image;

registering the face image in a storage unit as a master face image, in a state where whether a result of the age estimation satisfies a criterion is determinable;

when a person stands in front of equipment in which a specific product is displayed, acquiring a collation target face image capturing a face of the person being in front of the equipment, and collating the acquired collation target face image with the master face image registered in the storage unit;

when the master face image corresponding to the collation target face image is present in the storage unit, and a result of the age estimation satisfies a criterion, allowing the specific product to be taken out of the equipment;

when the master face image corresponding to the collation target face image is not present in the storage unit, executing age estimation by use of the collation target face image; and,

when the result of the age estimation satisfies the criterion, allowing the specific product to be taken out of the equipment, and registering the collation target face image as the master face image, together with the result of the age estimation, in the storage unit.
20. The sales support method according to any one of supplementary notes 17 to 19, further including,

by the sales support apparatus,

performing iris authentication or liveness determination of the person, before performing registration of the master face image in the storage unit.
21. The sales support method according to supplementary note 20, further including,

by the sales support apparatus:

registering, in the storage unit in association with the master face image, already-visited information indicating a time after payment processing of a product to be purchased, a time after elapse of a certain time, or going out of a store once; and,

when the already-visited information is registered in the storage unit, further performing the iris authentication or the liveness determination.
22. The sales support method according to any one of supplementary notes 17 to 20, further including,

by the sales support apparatus,

when performing of payment processing of a product to be purchased within the store is detected, erasing the master face image from the storage unit.
23. The sales support method according to any one of supplementary notes 17 to 20, further including,

by the sales support apparatus,

when the person going out of the store is detected, erasing the master face image from the storage unit.
24. The sales support method according to any one of supplementary notes 17 to 23, further including,

by the sales support apparatus,

when a certain time elapses after the master face image is registered in the storage unit, erasing the master face image from the storage unit.
25. A program causing a computer to execute:

a procedure of acquiring a face image capturing a face of a person being in front of equipment in which a specific product is displayed, and executing age estimation of the person by use of the face image;

a procedure of, when a result of the age estimation does not satisfy a criterion, requesting the person for age certification information, and determining whether the acquired age certification information satisfies a criterion; and

a procedure of, when a result of the determination satisfies a criterion, allowing the specific product to be taken out of the equipment, and registering the face image as a master face image, together with the age certification information, in a storage unit for subsequent occasions of authentication.
26. The program according to supplementary note 25, causing a computer to further execute

a procedure of accessing the storage unit when a result of the age estimation does not satisfy the criterion, and allowing the specific product to be taken out of the equipment when the master face image corresponding to the face image is registered together with the age certification information.
27. A program causing a computer to execute:

a procedure of, when a person enters a store, acquiring a face image capturing a face of the person, and executing age estimation by use of the face image;

a procedure of registering the face image in a storage unit as a master face image, in a state where whether a result of the age estimation satisfies a criterion is determinable;

a procedure of, when a person stands in front of equipment in which a specific product is displayed, acquiring a collation target face image capturing a face of the person being in front of the equipment, and collating the acquired collation target face image with the master face image registered in the storage unit;

a procedure of, when the master face image corresponding to the collation target face image is present in the storage unit, and a result of the age estimation satisfies a criterion, allowing the specific product to be taken out of the equipment;

a procedure of, when the master face image corresponding to the collation target face image is not present in the storage unit, executing age estimation by use of the collation target face image; and

a procedure of, when the result of the age estimation satisfies the criterion, allowing the specific product to be taken out of the equipment, and registering the collation target face image as the master face image, together with the result of the age estimation, in the storage unit.
28. The program according to any one of supplementary notes 25 to 27, causing a computer to further execute

a procedure of performing iris authentication or liveness determination of the person, before performing registration of the master face image in the storage unit.
29. The program according to supplementary note 28, causing a computer to further execute:

a procedure of registering, in the storage unit in association with the master face image, already-visited information indicating a time after payment processing of a product to be purchased, a time after elapse of a certain time, or going out of a store once; and

a procedure of, when the already-visited information is registered in the storage unit, further performing the iris authentication or the liveness determination.
30. The program according to any one of supplementary notes 25 to 28, causing a computer to further execute

a procedure of, when performing of payment processing of a product to be purchased within the store is detected, erasing the master face image from the storage unit.
31. The program according to any one of supplementary notes 25 to 28, causing a computer to further execute

a procedure of, when the person going out of the store is detected, erasing the master face image from the storage unit.
32. The program according to any one of supplementary notes 25 to 31, causing a computer to further execute

a procedure of, when a certain time elapses after the master face image is registered in the storage unit, erasing the master face image from the storage unit.

This application is based upon and claims the benefit of priority from Japanese patent application No. 2020-084544, filed on May 13, 2020, the disclosure of which is incorporated herein in its entirety by reference.

### REFERENCE SIGNS LIST

1 Sales system
3 Communication network
5 Camera
7 Equipment
10 Store
20 Product
22 Specific product
30 Portable terminal
40 Payment apparatus
80 Computer
100 Sales support apparatus
102 Age estimation unit
104 Age confirmation unit
106 Processing unit
108 Collation unit
130 Authentication unit
200 Storage apparatus
210 Authentication information
220 Age estimation result information
400 Screen
1000 Computer
1010 Bus
1020 Processor
1030 Memory
1040 Storage device
1050 Input/output interface
1060 Network interface

What is claimed is:

1. A sales support apparatus comprising:
at least one memory configured to store instructions; and
at least one processor configured to execute the instructions to:
acquire a face image capturing a face of a person being in front of equipment in which a specific product is displayed, and execute age estimation of the person by use of the face image,
when a result of the age estimation does not satisfy a criterion, request the person for age certification information, and determine whether the acquired age certification information satisfies a criterion, and,
when a result of the determination satisfies the criterion, allow the specific product to be taken out of the equipment, and register the face image as a master face image, together with the age certification information, in a storage unit for subsequent occasions of authentication.

2. The sales support apparatus according to claim 1, wherein the at least one processor is further configured to execute the instructions to
access the storage unit when a result of the age estimation does not satisfy the criterion, and allow the specific product to be taken out of the equipment when the master face image corresponding to the face image is registered together with the age certification information.

3. (canceled)

4. The sales support apparatus according to claim 1, wherein the at least one processor is further configured to execute the instructions to
perform iris authentication or liveness determination of the person, before performing registration of the master face image in the storage unit.

5. The sales support apparatus according to claim 4, wherein the at least one processor is further configured to execute the instructions to:
register, in the storage unit in association with the master face image, already-visited information indicating a time after payment processing of a product to be purchased, a time after elapse of a certain time, or going out of a store once, and,
when the already-visited information is registered in the storage unit, further perform the iris authentication or the liveness determination.

6. The sales support apparatus according to claim 1 wherein the at least one processor is further configured to execute the instructions to
when performing of payment processing of a product to be purchased within the store is detected, erase the master face image from the storage unit.

7. The sales support apparatus according to claim 1 wherein the at least one processor is further configured to execute the instructions to
when the person going out of the store is detected erase the master face image from the storage unit.

8. The sales support apparatus according to claim 1 wherein the at least one processor is further configured to execute the instructions to
when a certain time elapses after the master face image is registered in the storage unit, erase the master face image from the storage unit.

9.-16. (canceled)

17. A sales support method comprising,
by a sales support apparatus:
acquiring a face image capturing a face of a person being in front of equipment in which a specific product is displayed, and executing age estimation of the person by use of the face image;
when a result of the age estimation does not satisfy a criterion, requesting the person for age certification information, and determining whether the acquired age certification information satisfies a criterion; and,
when a result of the determination satisfies the criterion, allowing the specific product to be taken out of the equipment, and registering the face image as a master face image, together with the age certification information, in a storage unit for subsequent occasions of authentication.

18.-24. (canceled)

25. A non-transitory computer-readable storage medium storing a program causing a computer to execute:
a procedure of acquiring a face image capturing a face of a person being in front of equipment in which a specific product is displayed, and executing age estimation of the person by use of the face image;
a procedure of, when a result of the age estimation does not satisfy a criterion, requesting the person for age certification information, and determining whether the acquired age certification information satisfies a criterion; and
a procedure of, when a result of the determination satisfies the criterion, allowing the specific product to be taken out of the equipment, and registering the face image as a master face image, together with the age certification information, in a storage unit for subsequent occasions of authentication.

26-32. (canceled)
